(19) United States
(12) Patent Application Publication
(10) Pub. No.: US 2005/0066091 A1
(43) Pub. Date: Mar. 24, 2005

(54) Method for avoiding wrong input by determining environmental situation and system using the same

(76) Inventor: Wei-Sheng Tsai, Kaohsiung (TW)

Correspondence Address: BIRCH STEWART KOLASCH & BIRCH, PO BOX 747, FALLS CHURCH, VA, 22040-0747, US

(21) Appl. No.: 10/896,944

(22) Filed: Jul. 23, 2004

(30) Foreign Application Priority Data
Jul. 24, 2003 (TW) 92120214

(51) Int. Cl. G06F 13/12; G06F 13/38

(52) U.S. Cl. 710/74

(57) ABSTRACT

A method for avoiding wrong input by determining the environmental situation and the system using the method are provided. The system of the present invention includes a light-sensitive element, a processor and an input device. The light-sensitive element and the input device are electrically connected to the processor respectively. The light-sensitive element generates a light state responsive to an external light source, and the light state can change with the external light source. A processor selectively refuses to execute a partial request signal transmitted from the input device according to the light state. The method of the present invention includes: (a) detecting the light state of the light-sensitive element by the processor; (b) determining the environmental situation as in a normal state or a specific state; and (c) when the environmental situation is in the specific state, the processor refuses to execute the partial request signal from the input device.

### CROSS REFERENCE TO RELATED APPLICATIONS

This Application claims priority to Taiwan Patent Application No 92120214 entitled “A Method and Corresponding System of Preventing Wrong Input According to Environmental Situation,” filed on Jul. 24, 2003.

### FIELD OF THE INVENTION

The present invention relates to a method for avoiding wrong input by determining an environmental situation and a system using the method. More particularly, the method and the corresponding system are applied to mobile phones to avoid a user's wrong input.

### BACKGROUND OF THE INVENTION

An electronic apparatus is generally equipped with an input device for controlling purpose, for example, a keypad of a mobile phone, a control panel of a CD player and a touch pad of a personal digital assistant (PDA). However, the increasing mobility of the electronic apparatus nowadays causes a user's wrong input more frequently, and it results in an improper use of the electronic apparatus.

The solutions to the foregoing problem are adding a protective cover on the input device or installing a lock device within the input device. About a half of the mobile phones or PDAs are equipped with protective covers. Adding a protective cover can protect the input device completely; however, it subsequently increases the volume of the electronic apparatus and causes inconvenience.

A built-in lock device is usually set in the firmware of the electronic apparatus. Users give locking commands to the electronic apparatus by pressing specific functional keys, and the processor of the electronic apparatus will refuse to execute partial requests transmitted from input device. The keypad lock of the mobile phone is an exemplary representative of those lock devices.

### SUMMARY OF THE INVENTION

The present invention provides a method for avoiding wrong input where the method is used in an electronic apparatus. The method carries out a write-protection procedure responsive to the light state of the environmental situation.

The present invention also provides a method for avoiding a user's wrong input, wherein the write-protection procedure is initiated automatically after the electronic apparatus is exposed to the specific light state for a certain time.

The present invention also provides a method for avoiding a user's wrong input, and the method is used for an electronic apparatus. The electronic apparatus detects the light state of the environmental situation to execute a write-protection procedure.

The system of the present invention includes a light-sensitive element, a processor and an input device. The light-sensitive element generates a light state which is responsive to the environmental situation, and the light state can change with the environmental situation. The processor selectively refuses to execute partial requests transmitted from the input device.

The method of the present invention includes:(a) detecting the light state of the light-sensitive element by the processor; (b) determining whether the environmental situation is in a normal state or a specific state based on the light state; and (c) when the environmental situation is in the specific state, the processor refuses to execute partial request signals transmitted from the processor.

### BRIEF DESCRIPTION OF THE DRAWINGS

FIG. 1 shows a block diagram of the embodiment of the present invention.

FIG. 2a shows a flowchart of the embodiment of the present invention.

FIG. 2b shows a flowchart of another embodiment of the present invention.

FIG. 3a shows a block diagram of another embodiment of the present invention.

FIG. 3b shows a flowchart of another embodiment of the present invention.

### DETAILED DESCRIPTION OF THE INVENTION

The present invention provides a method for avoiding users' wrong input by determining the environmental situation, and provides a system using the same. The method and the system are used for an electronic apparatus. In the preferred embodiment, the environmental situation refers to the brightness of the light state of the environment. The mentioned electronic apparatus in the preferred embodiment is a mobile phone. However, in other embodiments, the electronic apparatus can be a PDA, a CD player, a digital camera or others with the same function.

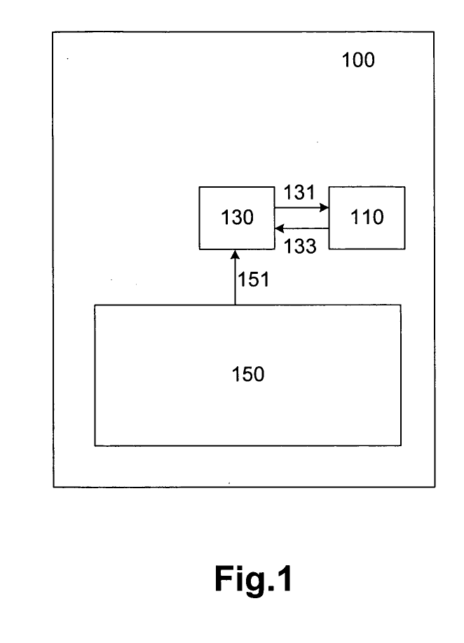

FIG. 1 shows a block diagram of the embodiment of the present invention. As shown in FIG. 1, the system of the present invention includes a light-sensitive element 110, a processor 130 and an output device 150. In the embodiment in FIG. 1, the system of the present invention is built in the electronic apparatus 100. The light-sensitive element 110 and the input device 150 are electrically connected to the processor 130 respectively. The light-sensitive element 110 generates a light state responsive to the environmental situation, and the light state can change with the brightness of the environmental situation. However, in other embodiments, the light state can change with the variation of the color composition of the environmental situation.

In preferred embodiments, the light-sensitive element 110 includes a photo-resistance. However, in other embodiments, the light-sensitive element 110 can be a charge coupled device (CCD) element or others with the same function. Besides, the input device 150 includes a keyboard in the preferred embodiment. However, in other embodiments, the input device 150 can be a voice input device, a touch pad or others with the same function.

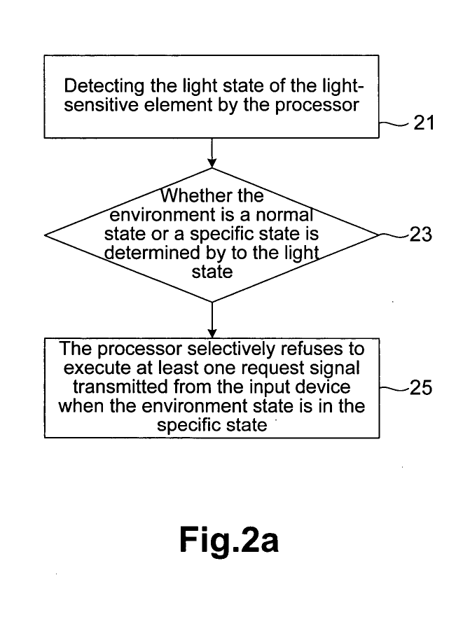

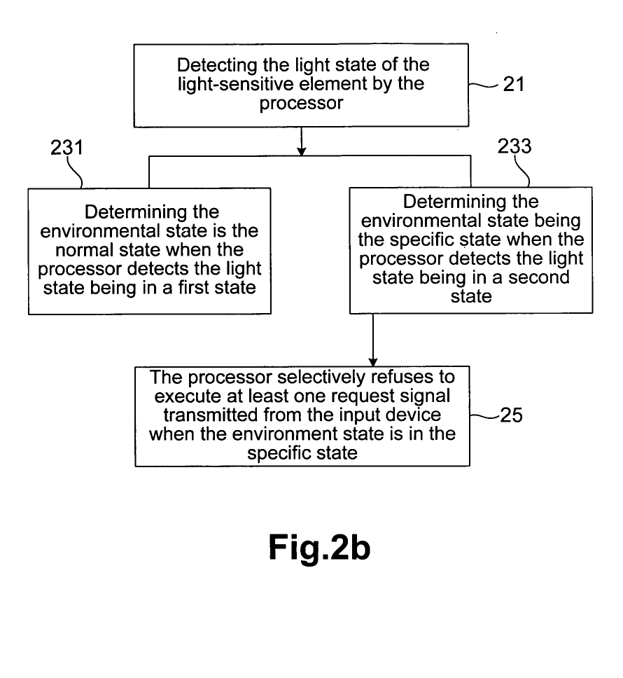

FIG. 2a shows a flowchart of the embodiment of the present invention. As shown in FIG. 2, the step 21 includes detecting the light state of the light-sensitive element 110 by the processor 130. In preferred embodiments, the processor 130 sends a detecting signal 131 to the light-sensitive element 110 and receives a responding signal 133 from the light-sensitive element 110, as shown in FIG. 1. The light-sensitive element 110 sends back different responding signals 133 according to different light states, so the processor 130 determines the light state according to the responding signal 133.

In the step 23, whether the environment is in a normal state or a specific state is determined by the light state. In this embodiment, the brightness in the normal state is greater than the brightness in the specific state. However, in other embodiments, the brightness in the normal and specific states can be contrary in relation to each other.

In the step 25, the processor 130 selectively refuses to execute at least one request signal 151 transmitted from the input device 150 when the environment state is determined to be the specific state. At least one request signal 151 as mentioned above includes an unanticipated request signal, for example, caused by users' unintentional pressing on the keypad. In other words, the step 25 is a procedure of locking the input device 150 to avoiding the users' wrong input. It should be noticed that the processor 130 can still selectively execute at least one request signal 151 transmitted from the input device 150, for example, a request signal of changing the locking state of the input device 150. However, in other embodiments, the processor 130 can also refuse to execute all the request signals 151 from the input device 150.

FIG. 2b shows a flowchart of another embodiment of the present invention. Comparing with the step in the embodiment in FIG. 2a, the step 23 in this embodiment further includes steps 231 and 233. The step 231 determines the environmental situation as in the normal state when the processor 130 detects the light state as in a first state. The step 233 determines the environmental situation as in the specific state when the processor 130 detects the light state as a second state. In this embodiment, the first state generates in response to the first external light source, and the second state generates in response to the second external light source, wherein the brightness of the first external light source is greater than the brightness of the second external light source.

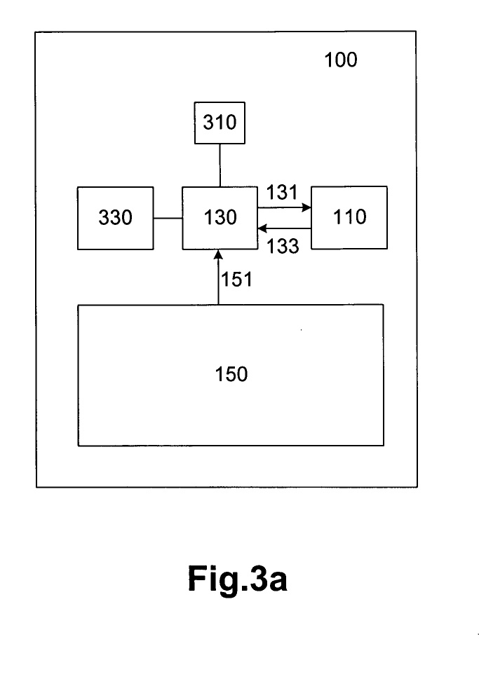

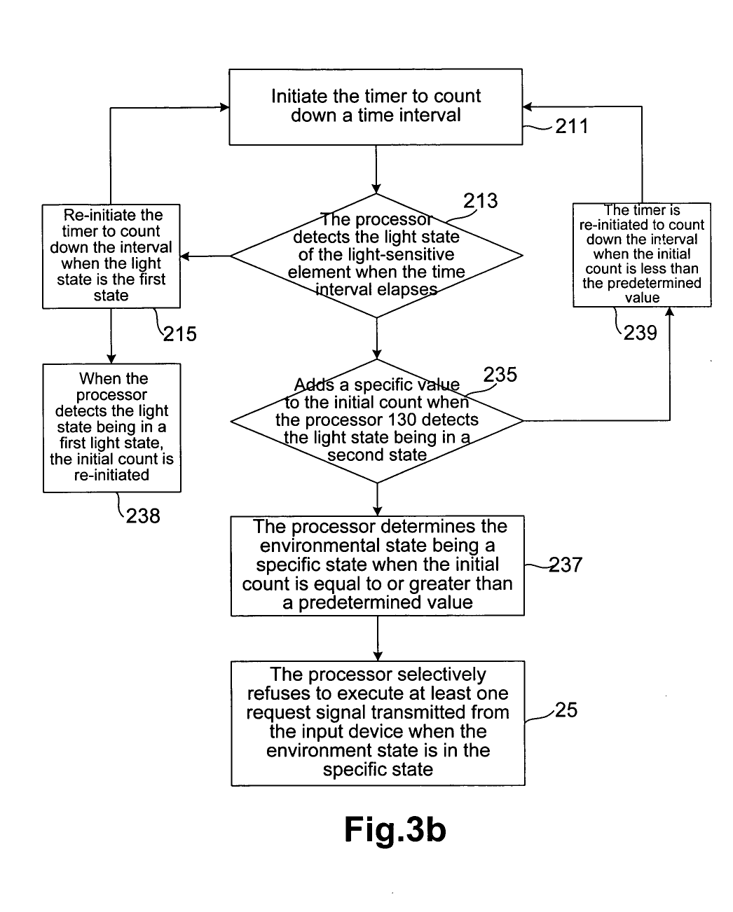

FIG. 3a shows a block diagram of another embodiment of the present invention. As shown in FIG. 3a, the processor 130 further includes a timer 310 and a count device 330. The count device 330 has an initial count value. In the embodiment, the timer 310 and the count device 330 are intangible and saved in the firmware in the processor 130. However, in other embodiments, the timer 310 and the count device 330 can be hardwares which are electrically connected to the processor 130.

FIG. 3b shows a flowchart of another embodiment of the present invention. The method in the FIG. 3b is applied to the system in FIG. 3a. As shown in FIG. 3b, the step 21 further includes steps 211, 213 and 215. The step 211 initiates the timer 310 to count down a time interval. The time interval here is a predetermined time period and can be changed as needed. The processor 130 detects the light state of the light-sensitive element 110 when the time interval elapses in the step 213. The step 215 re-initiates the timer 310 to count down the interval when the light state is the first state. After the step 215 ends, return to the step 211, and the processor 130 detects the light-sensitive element 110 on each time interval. Only when the light state is the second state, can the next stage be executed. It should be noticed that the mentioned interval remains unchanged during the period of detection in the preferred embodiment. However, in other embodiments, each interval can be different from each other. For instance, intervals can be in a functional relationship or an irregular relationship.

As shown in FIG. 3b, the step 23 further includes steps 235, 237, 238 and 239. In the step 235, a specific value is added to the initial count value, when the processor 130 detects the light state as a second state. In the preferred embodiment, the specific value is 1. In the step 237, the processor 130 determines the environmental situation as a specific state when the initial count value is equal to or greater than a predetermined value.

In step 238, when the processor 130 detects the light state as a first light state, the initial count value is re-initiated. In the preferred embodiment, the initial count is set to zero. In the step 239, the timer 310 is re-initiated to count down the interval when the initial count value is less than the predetermined value. In other words, when the initial count value is less than the predetermined value, the procedure returns to the step 211.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. A method for avoiding wrong input to an electronic apparatus based on an environmental situation, the electronic apparatus including a light-sensitive element, a processor and an input device, the light-sensitive element and the input device electrically connected to the processor respectively, the light-sensitive element, responsive to the environmental situation, generating a light state, the input device selectively transmitting a request signal to the processor, the method comprising:
(a) detecting the light state of the light-sensitive element by the processor;
(b) determining whether the environmental situation is in a normal state or a specific state based on the light state; and
(c) when the environmental situation is in the specific state, the processor selectively executsing partial request signal.

2. The method of claim 1, wherein the processor includes a timer, the step (a) further comprising:
initiating the timer to count down a time interval; and
checking the light state of the light-sensitive element by the processor as the time interval elapses.

3. The method of claim 2, wherein the step (a) further comprises:
when the light state is detected as a first state, re-initiating the timer to count down the time interval.

4. The method of claim 1, wherein the step (b) further comprises:
when the light state is detected as a first state, the environmental situation is determined as in the normal state.

5. The method of claim 1, wherein the step (b) further comprises:
when the light state is detected as a second state, the environmental situation is determined as in the specific state.

6. The method of claim 1, wherein the processor includes a timer, the timer including an initial count value, the step (b) further comprising:
when the light state is a second state, a specific value is added to the initial count value; and
when the initial count value equals to or greater than a predetermined value, the processor determines the environmental situation as in the specific state.

7. The method of claim 6, wherein the step (b) further comprises:
when the light state is a first state, re-initiating the timer.

8. The method of claim 6, the step (a) further comprising:
initiating the timer to count down a time interval; and
detecting the light state of the light-sensitive element as the time interval elapses; and
the step (b) further comprising:
when the initial count value is less than the predetermined value, re-initiating the timer to count down the time interval.

9. A system for avoiding accident input to an electronic apparatus based on an environmental situation, the system comprising:
a light-sensitive element;
a processor electrically connected to the light-sensitive element; and
an input device electrically connected to processor;
wherein the light-sensitive element, responsive to the environmental situation, generates a light state, the input device selectively transmits a request signal to the processor, and when the light state is a specific state, the processor selectively executes the request signal.

10. The system of claim 9, wherein the processor includes a timer to count down a time interval.
